(19) United States
(12) Patent Application Publication
(10) Pub. No.: US 2013/0343779 A1
(43) Pub. Date: Dec. 26, 2013

(54) System and Methods for Remanufacturing Print Cartridges and Tracking Quality Thereof

(71) Applicant: Harry E. Nicodem, McHenry, IL (US)

(72) Inventor: Harry E. Nicodem, McHenry, IL (US)

(21) Appl. No.: 13/925,360

(22) Filed: Jun. 24, 2013

Related U.S. Application Data
(60) Provisional application No. 61/663,376, filed on Jun. 22, 2012.

(51) Int. Cl. G03G 15/00

(52) U.S. Cl. CPC G03G 21/181
USPC 399/109

(57) ABSTRACT

Disclosed are a system and methods for remanufacturing print cartridges and tracking the quality thereof. The system and methods may provide a workstation that allows an operator to test, evacuate, clean, refill, and verify the success of a remanufactured print cartridge. The system and methods further provide for quality management of a remanufacturing process in which vendors and remanufacturers have access to data, including statistics on remanufacturing, product supplies, accounting, etc., creating a transparent market for buying and selling remanufactured print cartridges.

### PRIORITY STATEMENT

This application claims the benefit of U.S. Provisional Application No. 61/663,376, filed Jun. 22, 2012.

### FIELD OF THE INVENTION

The present invention relates generally to the remanufacture of print cartridges and quality management pursuant to the remanufacture of print cartridges, and more specifically, the present invention relates to a system and methods for quickly and efficiently remanufacturing multiple print cartridges and tracking the remanufacturing cycle of print cartridges for information relating to, among other things, quality, reliability, returns and print cartridges that cannot be remanufactured or are unsuccessfully remanufactured.

### BACKGROUND OF THE INVENTION

Printers are used today in home and businesses at record levels. Over time, printers have become relatively inexpensive, often selling for less than $100. Much of the revenue derived in the printing industry is generated when a printer cartridge runs dry and needs to be replaced. In fact, over the life of the printer, a consumer will spend much more on inkjet printer cartridges than the cost of the initial printer.

Inkjet cartridges are the replaceable part of the printer that stores and supplies the ink to the paper during the printing process. Inkjet cartridges contain one or more partitioned ink reservoirs, and often contain electronic contacts and chips that communicate with the printer.

Consumers and businesses using ink or laser print cartridges today have a choice of whether to discard print cartridges or to reuse and recycle the cartridges, often referred to as “remanufacturing”. By choosing to reuse and recycle print cartridges, consumers and businesses can save money and do their part to reduce waste and save energy. Remanufacturing, in general, is to refill the print cartridge with one or more different colored or black inks so that the cartridge can be placed back in the printer and used again.

Print cartridges can be remanufactured several times before they should be retired. Remanufacturing a single print cartridge multiple times can prevent over a pound of waste from entering a landfill and save about a gallon of oil. While these savings may sound small on a per-print cartridge basis, the numbers add up when considering that over 300 million print cartridges will be discarded in landfills each year, with that number predicted to increase each year.

Many existing print cartridge refilling stations focus only on refilling cartridges with ink or toner. Other existing print cartridge refilling stations add the capability to remove any remaining ink or toner remaining in the cartridge. Removing ink or toner that remains in the cartridge, though, can be a time-consuming process, especially considering that existing refilling stations typically perform this removal process one cartridge at a time.

A further shortcoming of existing refilling stations pertains to quality control. For one reason or another, a fraction of all print cartridges either fail during the remanufacturing process or fail after remanufacture. Some of these failed print cartridges can be caught in the store through testing, where, for example, the electrical contacts, ink passageways, or nozzles on the print cartridge are determined to be nonfunctioning.

When remanufactured print cartridges fail in the possession of consumers or businesses, however, consumers and businesses that purchase remanufactured print cartridges have to return the print cartridges. These failures are particularly disadvantageous for the reputation of print cartridge vendors, and sometimes for the retail stores that sell the cartridges. Regardless of where the print cartridge failure occurs, refilling stations and the general print cartridge remanufacturing industry do not have a quality management system that allows vendors of print cartridges to track print cartridges that are failing.

Thus, there is a long felt need in the print cartridge remanufacturing field for a method and system that allow numerous print cartridges to be quickly and efficiently remanufactured, including testing, emptying, cleaning, refilling and testing for proper remanufacturing. There is also a need for a system that allows vendors and distributors of print cartridges to monitor the quality of the remanufacturing process and determine which print cartridges are failing and why.

### SUMMARY OF THE INVENTION

One aspect of the present disclosure provides a system and method for quickly and efficiently remanufacturing print cartridges. In an embodiment, the system may include a workstation and a vacuum. The workstation may include a test module configured to perform an electrical test on contacts of a first print cartridge and performing a print quality test on the first print cartridge and a filling cradle configured to clean fill the first print cartridge with ink. The vacuum may include a chamber configured to contain at least the first print cartridge and a second print cartridge. The vacuum may be configured to evacuate ink from the first and the second print cartridge. Some of the merely exemplary advantages of the disclosed workstation include accelerating and improving efficacy of the cartridge cleaning process, reducing cleaning fluid usage, and reducing environmental impact due to a reduction in waste water.

To help accelerate and improve the efficacy of this remanufacturing process, the system may use a variety of advanced techniques on the print cartridge. These techniques may include, for example, forced water circulation, agitation of the print cartridge by periodic admission of air at a relative pressure higher than that within a cleaning chamber, pulsed or continuous ultrasonic or other acoustic energy, vacuum cycling where the internal pressure of the cleaning chamber is varied between a multiplicity of pressure levels, or elevated temperatures. A combination or sequence of these techniques may be applied as well.

The workstation may be used to perform a method of remanufacturing a print cartridge. The vacuum may first be used to evacuate ink from the cartridge. In one embodiment the vacuum may accommodate up to or more than 100 print cartridges. The vacuum may remove any excess ink or toner that remains in the print cartridges. By removing excess ink or toner from a group of print cartridges at once, a significant amount of time is saved, or at least reduced, where each print cartridge would otherwise be individually evacuated in a filling cradle, as described below. In some embodiments, a centrifuge may also be used to evacuate even more ink and/or toner from the print cartridge.

The test module may then be used to perform an electrical test on electrical contacts of the print cartridge, which is one of the first steps in the remanufacturing process. Electronically defective print cartridges may be rejected even before refilling the print cartridge with ink. In an alternate embodiment, the electrical test may be performed before evacuating ink from the cartridge.

Once any remaining ink is removed from the print cartridge and the electrical test is passed, the print cartridge may be put into one or more filling cradles onboard the workstation. The filling cradles are where the print cartridges are actually filled. Once in place, further steps in the remanufacturing process may be initiated. For example, a print head of the print cartridge may be cleansed, a reservoir and any conduits of the print cartridge may be further evacuated, and the reservoir may be filled with ink. It should be noted, however, that it may not be necessary to further evacuate the print cartridge before refilling it. But, at least where print cartridges are further evacuated, the time required to do so is reduced significantly due to the benefits of the vacuum cleaning process.

Prior to the filling process, a fluid flow test or other quantitative measurement method may be employed, to determine the qualitative condition of the cartridge's various ink passageways and print nozzles, which are subject to damage and degradation for various reasons. This testing process permits avoidance of dispensing ink into cartridges which will fail either immediately or soon afterward, or at the end user's premise. This method results in further overall process time reduction and increased quality of the remanufactured cartridge.

In an embodiment, a fluid flow test may employ a test fluid or priming fluid wholly compatible with the chemistry of the inks used in the subsequent filling process. This test fluid may be devoid of pigmentation or coloration so as not to contaminate either color or black cartridges during or after the test. Furthermore, a test fluid may be fully miscible with the inks used in the filling process.

After the flow testing process, some embodiments offer the capability to generate an identification mark that identifies the cartridge as having met the flow test criteria. This aspect has value as a method of qualifying cartridges for resale to other remanufacturers, particularly in the case of scarce or otherwise highly sought-after cartridges. In an embodiment, a barcode label may be printed and affixed to the cartridge, identifying it as being acceptable for filling.

In an embodiment, the identification and labeling of flow tested cartridges may be integrated with a system of electronically recording and exchanging the cartridges via a database such that the availability status of the cartridge can be shared and managed among the consumers of these cartridges, and thus allow the system to act as a factor in the cartridge “core” supply/demand loop.

In some embodiments, filling the reservoir may occur through the print head, particularly for black cartridges. In other embodiments, filling the reservoir may occur through the use of needles, particularly for color cartridges. Once filled, the workstation may prompt the operator to move the print cartridge back to one of the test modules. The present disclosure also contemplates automating certain processes disclosed herein such that the operator of the workstation would not have to move the print cartridge back to the test module, for example.

One of the test modules may perform a print quality test where the refilled print cartridge is used to print a high quality test pattern on a piece of paper. In one embodiment, the workstation may have an optical sensor that examines the test pattern as a quality control check. In another embodiment, the operator of the workstation may visually inspect the test pattern. In either case, if the test pattern is satisfactory, the print cartridge may leave the workstation to be repackaged for resale, for example. If the test pattern is unsatisfactory, the print quality test may be repeated. If the print cartridge does not perform sufficiently, the print cartridge may be discarded or may be set aside and made available for a vendor's inspection.

In some embodiments, the remanufacturing workstation may include the capability to electronically manipulate circuitry carried by the cartridge, and integrate this capability with the overall remanufacturing and quality management process. In one embodiment, this capability provides for the remanufactured cartridge to be accepted by the end-user's printer in essentially the same manner as a new cartridge from the original equipment manufacturer.

The operator of the workstation may use a graphical user interface (GUI) onboard the workstation to control each aspect of the workstation, from evacuating ink or toner to testing the print cartridge after refilling, for example. The GUI may be configured to a computer running any of a number of operating systems. In one embodiment, the GUI is a touch screen monitor through which the entire workstation may be controlled. The GUI may work in conjunction with a “mouse,” a keyboard, and the like. The workstation may also include hardware for wired or wireless connectivity such that the computer can connect to the internet and/or a network. This capability makes tasks such as updating software and firmware simple.

The GUI may be used to convey dynamic information directly to the operator of the workstation and to differentiate between multiple users such that both global and user-specific information may be delivered via the GUI's display element and/or audible element. This capability provides great value to the operator and owner of the machine. In one embodiment, this capability is used to offer training information, performance and quality data, and production statistics to users of the workstation.

A further embodiment provides for an information repository to which users may contribute data. This allows for collaborative process improvement and information sharing, which may have great value in improving the consistency and quality of remanufactured cartridges.

A further aspect of the present invention is the ability of the workstation in some embodiments to print a label to be placed on each print cartridge during or after print cartridge remanufacturing. The label may include a variety of information such as, for example, a unique barcode or identifier that identifies each print cartridge, an abbreviation representing the vendor and/or original equipment manufacturer (OEM), a cartridge model, a name of an operator that refilled the print cartridge, one or more dates on which the print cartridge was refilled, a location of the store at which the print cartridge was refilled, how many times the cartridge has been refilled, what types of ink the print cartridge has held, and the like.

In the alternative, an online database or a network may store (and allow for retrieval) all the exemplary information recited above in a record associated with the particular print cartridge. The unique barcode could identify a particular print cartridge within the online database or network that would allow an individual to trace the complete history of the print cartridge. Thus, all of this information would not necessarily need to be printed on the label.

Still another aspect of the disclosed system and method concerns tracking the quality of print cartridges, particularly the ability of particular print cartridges to be successfully remanufactured. As described briefly above, a fraction of all print cartridges are not remanufacturable. This may be discovered, for example, after the print cartridge is tested at the test module of the workstation. Or this may be discovered only after a remanufactured print cartridge is resold to a consumer or business. In the later case, the customer or business will likely report the failure of the print cartridge. In some embodiments, it may help to incentivize the consumer to report failures by promising to replace the print cartridge upon failure, for example.

An exemplary method of tracking remanufactured print cartridges may include recording data regarding a plurality of remanufactured print cartridges, the information comprising identification information respective of each print cartridge and instances of unsuccessful remanufacture. Identification information may include manufacturer, model number, and other information. Such identification information may be automatically recorded by a workstation, in an embodiment, by scanning a barcode on a label on the cartridge. For example, if a print cartridge fails an electrical test, a workstation may record that failure. Similarly, if a remanufactured cartridge is returned to the vendor operating the workstation, the workstation could be used to record that return. A cause of failure may be recorded, as well.

The method may further include uploading the data to a database via an internet portal. By uploading the data, information regarding failure rates and failure causes for a large number of cartridges from a large number of workstations may be consolidated in a central database for analysis and dissemination.

The tracking method may further include generating a report regarding the success of remanufacturing the plurality of remanufactured print cartridges according to the data stored in the database. Because it may be based on consolidated information from a number of workstations, the report may be more informative and useful to both consumers and vendors than any similar report based on information from only a single source. Reports may be generated by the database (e.g., by a computing system at the database) or by a workstation with access to the database, in embodiments.

Reports may include statistics that vendors can customize based on region, OEM, print cartridge model, year of production, number of remanufactures, and so on. In short, the statistics may be broken down per each vendor's preferences, per each piece of information associated with each print cartridge. In turn, vendors may be able to compare their return data and return trends with their competitors' return data and trends. Moreover, print cartridge remanufacturers may be able to view their return data and modify their purchasing patterns.

Tracking the quality of print cartridges may be particularly helpful where new print cartridges are introduced into the market. When a new print cartridge is introduced, vendors and print cartridge remanufacturers may not know the probabilities of successfully remanufacturing the print cartridge. By collecting data on the database, vendors and remanufacturers may be able to quickly hone aftermarket buying and selling prices for the print cartridge. As an extension of this, vendors and remanufacturers may also be able to determine price points for commodities associated with the remanufacture of the particular print cartridge, such as ink, paper, and labels, for example.

### BRIEF DESCRIPTION OF THE DRAWINGS

The preferred embodiments of the invention will be described in conjunction with the appended drawings, which illustrate and do not limit the invention, where like designations denote like elements, and in which:

FIG. 1 is an isometric view of an exemplary embodiment of a system for remanufacturing print cartridges.

FIG. 2 illustrates a portion of an exemplary graphical user interface that may be provided by the system of FIG. 1.

FIG. 3 is an isometric view of an exemplary barcode scanner that may be included in the system of FIG. 1.

FIG. 4 is a schematic diagram of an exemplary vacuum that may be included in the system of FIG. 1.

FIGS. 5-7 are various isometric views of an exemplary vacuum that may be included in the system of FIG. 1.

FIG. 8 is an isometric view of an exemplary test printer that may be included in the system of FIG. 1.

FIG. 9 is an isometric view of an exemplary ink supply and exemplary ink waste reservoir that may be included in the system of FIG. 1.

FIG. 10 is an isometric view of an exemplary scale that may be included in the system of FIG. 1.

FIG. 11 is an isometric view of an exemplary label printer that may be included in the system of FIG. 1.

FIG. 12 is an exemplary label that may be printed by the label printer of FIG. 11 for application to a print cartridge remanufactured by the system of FIG. 1.

FIG. 13 is an isometric view of an exemplary network port that may be included in a workstation of the system of FIG. 1.

FIG. 14 is a diagrammatic view of a quality management system for remanufactured print cartridges.

FIG. 15 is a flow chart illustrating an exemplary method of tracking remanufactured print cartridges.

### DETAILED DESCRIPTION OF EMBODIMENTS OF THE INVENTION

The present disclosure generally includes systems and methods for the remanufacture of print cartridges and quality management of remanufactured print cartridges. Systems and methods according to the present disclosure enable rapid, efficient remanufacturing of multiple print cartridges and tracking the remanufacturing cycle of those print cartridges for information relating to, among other things, quality, reliability, returns, and print cartridges that cannot be remanufactured or are unsuccessfully remanufactured.

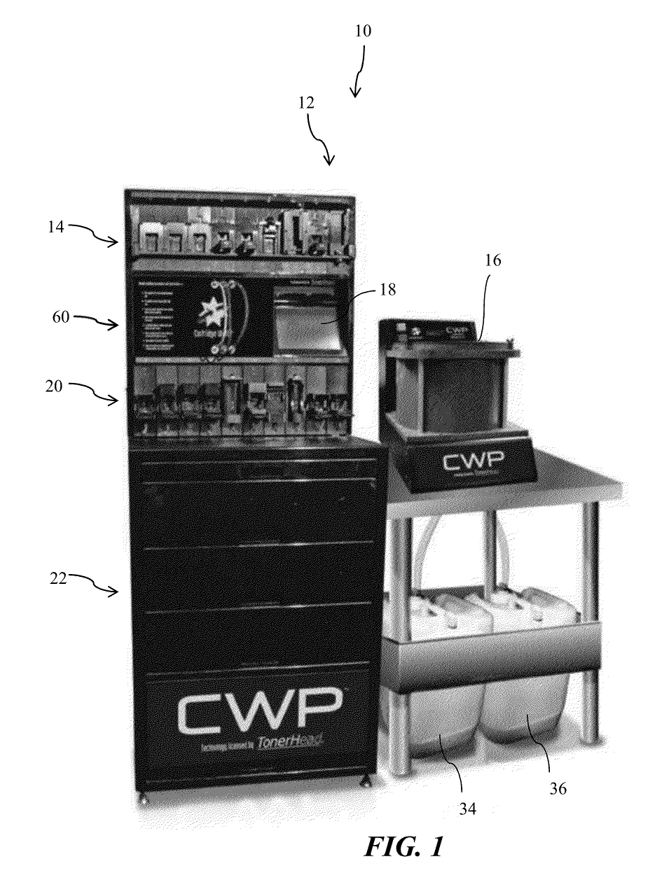

Referring to the figures, in which like reference numerals indicate the same or similar components in the various views, FIG. 1 is an isometric view of an exemplary system 10 for remanufacturing print cartridges. The system 10 may find use with numerous different brands and models of inkjet print cartridges, in an embodiment, and may enable testing, cleaning, and filling used cartridges.

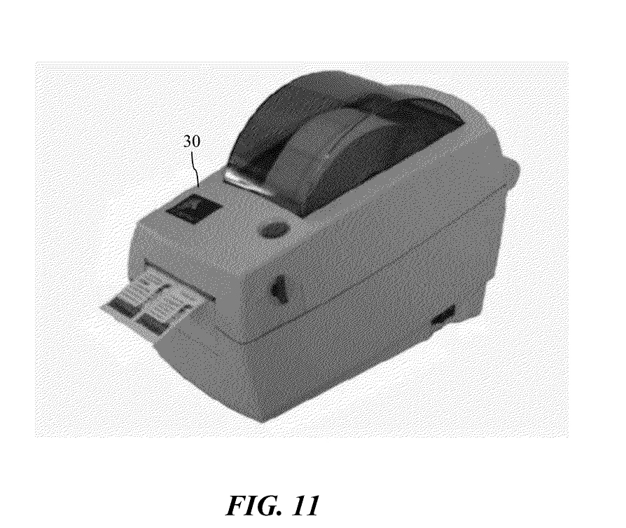

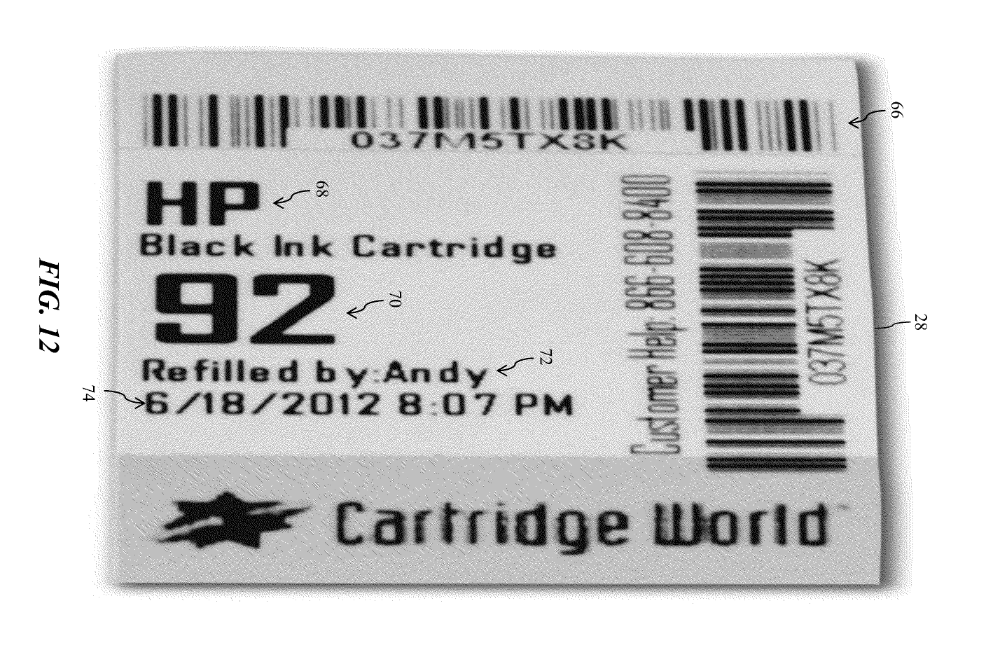

The system 10 may include a workstation 12 at least for cleaning, testing, evacuating, and refilling print cartridges, or combinations thereof. In one embodiment, the workstation 12 may include one or more test modules 14, a vacuum 16, a display 18 on which the workstation may provide a graphical user interface (GUI), one or more filling cradles 20, and one or more drawers 22. The workstation 12 may also include a barcode scanner 24 (see FIG. 3), test print feeder 26 (see FIG. 8), scale 28 (see FIG. 10) and label printer 30 (see FIG. 11), among other devices, peripherals, and functionality.

Many aspects of an embodiment of the workstation 12 are shown and described in U.S. patent application Ser. No. 11/379,717, published as U.S. patent application publication 2007/0085883, which application and publication are hereby incorporated by reference in their entireties. In addition, components of the workstation 12 are described herein.

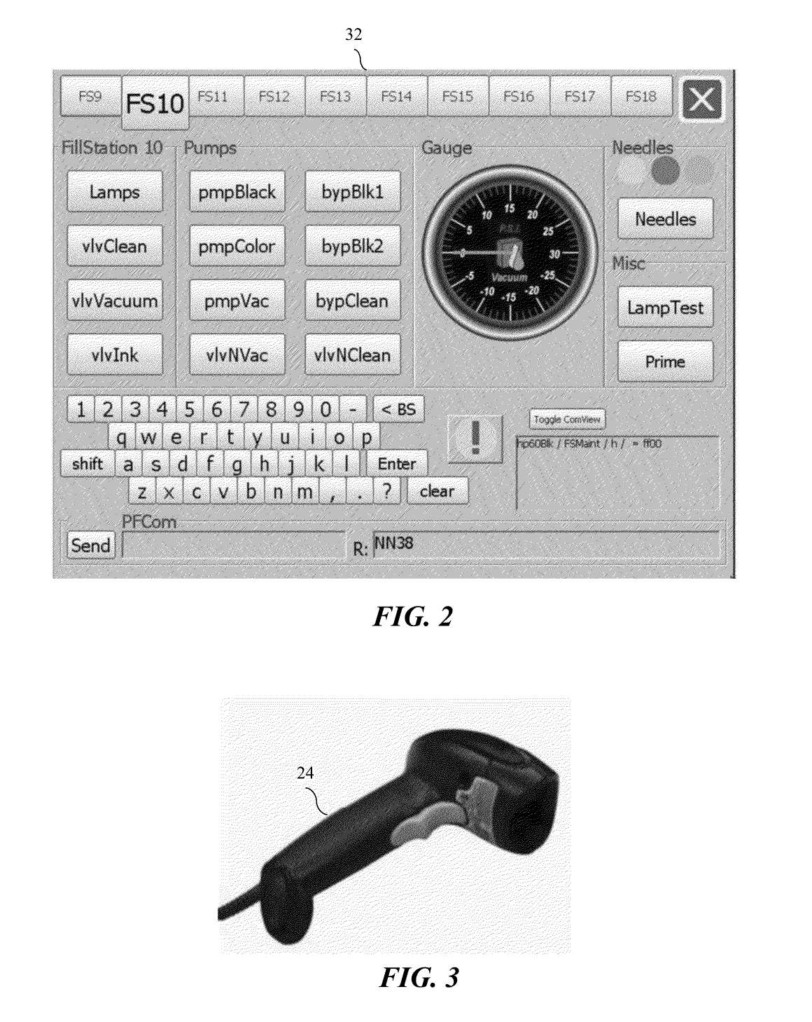

Referring to FIGS. 1 and 2, the workstation 12 may be configured to provide a GUI 32 on the display 18. The GUI 32 may provide a user of the workstation 12 with, for example and without limitation, training information, performance and quality data, production statistics, instructions for various procedures that may be performed with the workstation 12, including print cartridge testing, emptying, and refilling, and well as instructions for installing and replacing components of the system itself. The instructions may include images and/or text, and may be selectable by the user via one or more menus. The GUI 32 may also allow a user to enable and disable hardware for wired or wireless connectivity to the Internet, to a network, to a server, etc. This capability may make tasks such as updating software and firmware simple.

The GUI 32 may also provide a user an interface through which one or more of the test modules 14, the filling cradles 20, and the vacuum 16 may be controller and monitored. For example, a user may initiate an electrical test of a cartridge coupled with a test module 14 through the GUI 32 and view the results of the test on the GUI 32. Similarly, a user may initiate an ink filling operation through the GUI 32 for a cartridge coupled with a filling cradle 20 and view results of the ink filling operation through the GUI 32. For example, through the GUI portion shown in FIG. 2, a user may initiate a number of manual operations through selection of an appropriate button, such as priming the workstation, operating the vacuum, and inserting ink into a print cartridge.

It should be understood that FIG. 2 illustrates a single exemplary portion of the GUI 32 and that the GUI 32 may additionally include numerous other views, menus, information, etc. Accordingly, the GUI 32 is neither limited to the view shown in FIG. 2 nor required to include the view shown in FIG. 2 except as otherwise set forth in the appended claims.

Referring again to FIG. 1, the workstation 12 may comprise, in an embodiment, processing capabilities for performing the operations described above and below (e.g., providing the GUI 32, performing electrical tests on cartridges, filling cartridges, and printing test strips and labels). Such processing capabilities may be embodied in hardware, software, or a combination of hardware and software. Furthermore, the processing capabilities of the workstation 12 may be embodied in a single controller or computing system or may be distributed among several components.

The display 18 may be a touch screen, in an embodiment. Accordingly, the user may be able to interact with the information provided on the display (e.g., through the GUI 32) via touch interaction. In the same or a different embodiment, various additionally input mechanisms may be provided for user input, such as, but not limited to, a keyboard and mouse. Thus, the user may also be able to interact with the information provided on the display 18 via one or more external input mechanisms. In addition, the visual output of the GUI 32 may be supplemented with audible output, in an embodiment.

The GUI 32 may also provide the user information regarding the status of a print cartridge, including the history of a print cartridge (e.g., original manufacture information, number of remanufactures, past issues, etc.), current status of a print cartridge (e.g., test result information, status of remanufacturing steps). In an embodiment, the GUI 32 may be configured to provide a status of a print cartridge automatically (e.g., in response to a test or filling operation initiated by a user or a barcode scanning) or in response to an explicit instruction from a user to display a cartridge status.

A procedure for remanufacturing a print cartridge with the system 10 may generally include a number of steps performed under the direction of instructions provided, in embodiments, by the workstation 12 through the GUI 32 and/or performed automatically by the system 10 and its components. A first step in a remanufacturing process for a cartridge may involve removing ink from the cartridge. Ink removal may be performed with the vacuum 16. In an embodiment, the vacuum 16 may be configured to contain and remove ink from a plurality of cartridges at the same time. The vacuum 16 may be coupled with a water reservoir 34 or other fluid source and a waste reservoir 36. The operations of the vacuum 16 may be controlled and monitored by the workstation 12, in an embodiment. A user may command the vacuum 16 and view progress of vacuum operations through the GUI 32, in embodiments. The vacuum 16 may also be operated separately from the workstation 12.

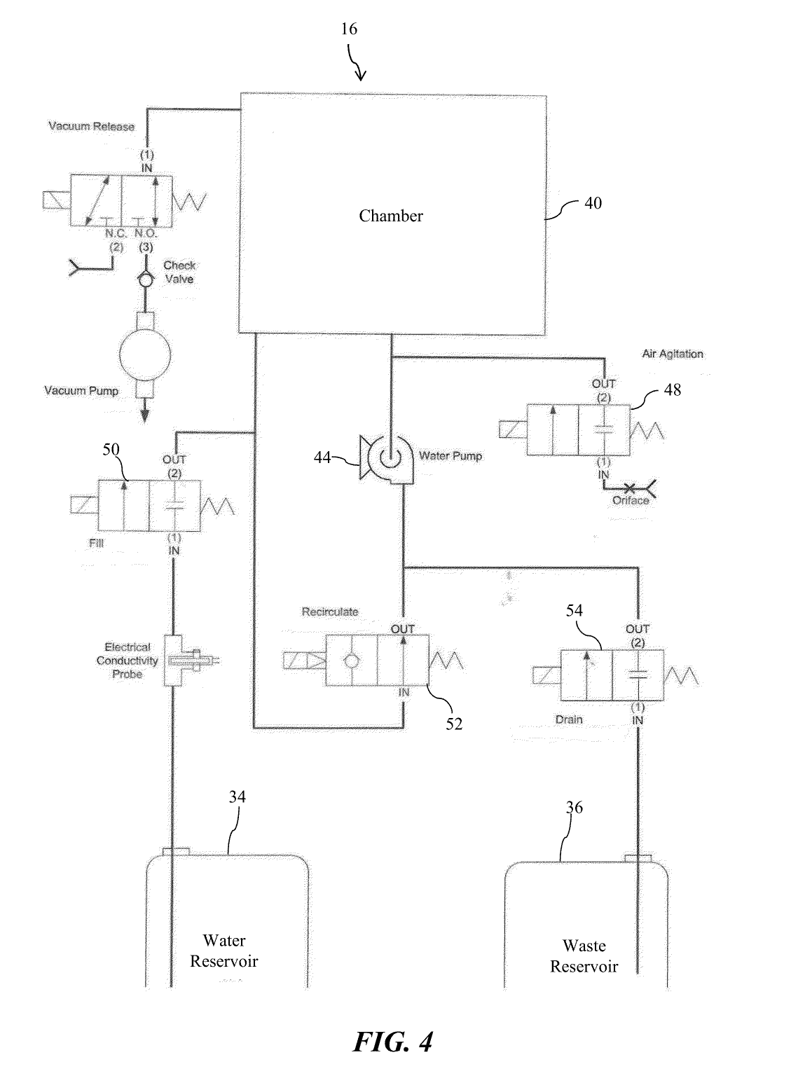

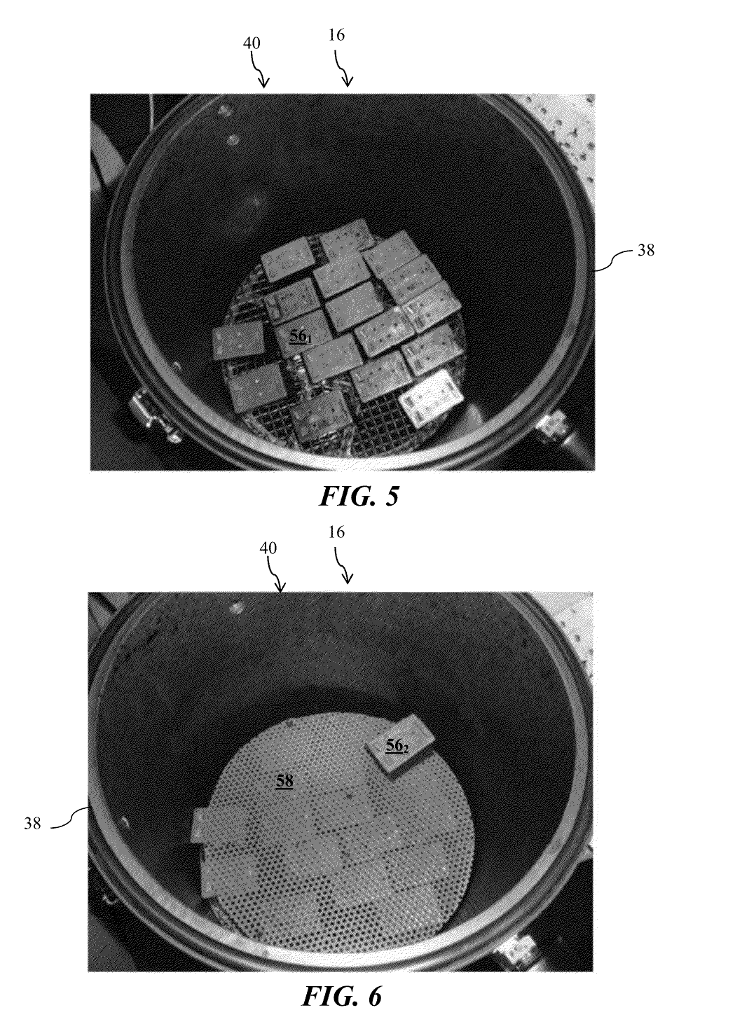

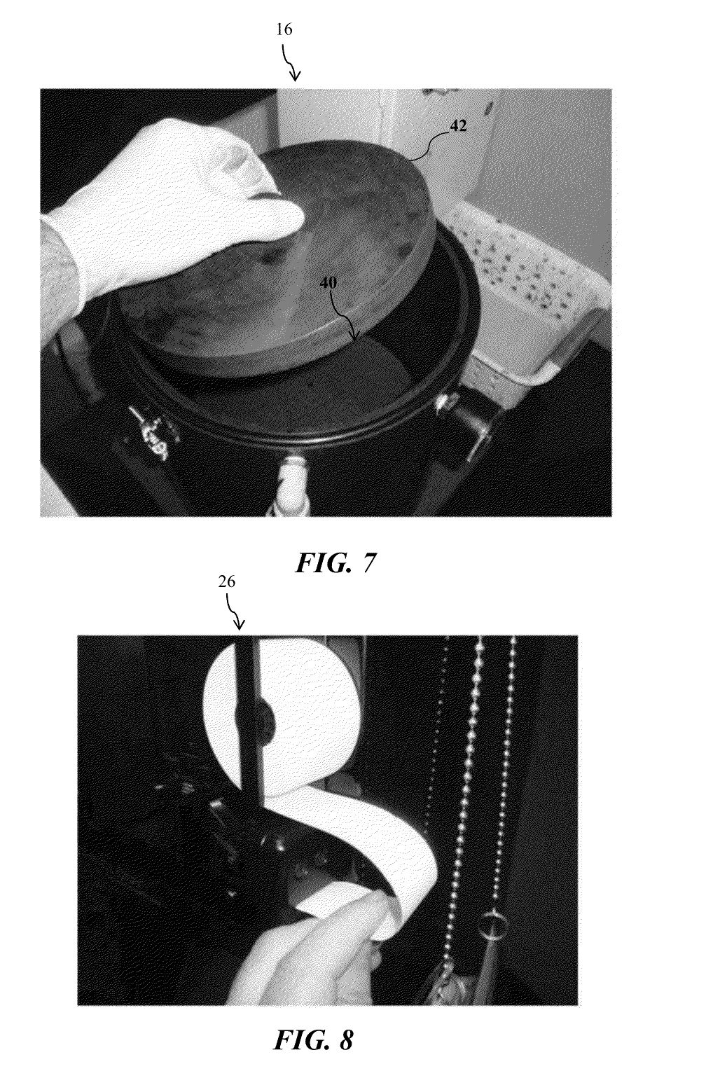

FIG. 4 is a schematic of an exemplary embodiment of the vacuum 16, and FIGS. 5-7 are various isometric views of an embodiment of the vacuum 16. Referring to FIGS. 4-7, the vacuum 16 may include a body 38, a primary chamber 40, a lid 42, a water pump 44, a recirculation valve 46, an air agitation valve 48, a water fill valve 50, a recirculation valve 52, and a drain valve 54. The vacuum 16 may be coupled with a water reservoir 34 or other fluid source and with a waste reservoir 36 or other waste destination. The components of the vacuum 16 may be configured to, e.g., increase the pressure within the chamber 40 where numerous print cartridges may be stored to force ink out of the cartridge reservoirs, sponges inside the reservoirs and conduits of the print cartridges. Evacuated ink may be emptied into the waste reservoir.

In some embodiments, the vacuum 16 may be considered part of the workstation 12 (as described above with respect to FIG. 1). In other embodiments, though, the vacuum 16 may be considered a separate component. Either way, the vacuum 16 may be arranged adjacent to the filling cradles 20 and test modules 14, or the vacuum 16 may be built into an upright structure of the workstation 12 that contains and supports the test modules 14, fillings cradles 20, and drawers 22.

To empty multiple cartridges at a time with the vacuum 16, a process illustrated in FIGS. 5-7 may be used. First, a first set of cartridges 56₁ may be placed on the bottom of the interior of the vacuum chamber 40, as shown in FIG. 5. A divider 58 may be placed on top of the first set of cartridges 56₁, and a second set of cartridges 56₂ placed on top of the divider 58₁, as shown in FIG. 6. Numerous dividers 58ₖ, 58₂, . . . 58_{N} and layers of cartridges 56₁, 56₂, . . . 56_{N+1} may be placed in the vacuum chamber 40. In an embodiment, up to three layers of cartridges 56 may be effectively emptied at the same time with the vacuum. After stacking the desired number of layers of cartridges 56 and dividers 58, the lid 42 may be placed on top of the vacuum 16 to seal the chamber 40.

The vacuum 16 may agitate print cartridges by periodic admission of air at a relative pressure higher than that within the primary (or cleaning) chamber 40. The vacuum 16 may also be equipped to exert pulsed or continuous ultrasonic or other acoustic energy at the print cartridges. Additionally or alternatively, or one or more of the filling cradles may be configured to exert pulsed or continuous ultrasonic or other acoustic energy at the print cartridges (e.g., after evacuating ink with the vacuum, in an embodiment). Further, vacuum cycling may be used where the internal pressure of the cleaning chamber 40 is varied between a multiplicity of pressure levels. The vacuum 16 may also be capable of changing the temperature within the chamber 40 to help evacuate ink or toner from the print cartridge. The vacuum 16 may be capable of utilizing a combination or sequence of these techniques as well. In addition, in embodiments, the vacuum 16 may function as a centrifuge. Centrifugal movement of the chamber 40 may be separate from or combined with any of the other operations of the vacuum. Additionally or alternatively, a separate centrifuge may be provided.

In an embodiment, the vacuum 16 may operate according to a particular sequence of air pressure changes, fluid circulation, and air agitation. An exemplary such method may include the following sequence: (1) reduce air pressure in the chamber 40 of the vacuum 16; (2) fill the chamber 40 with water from the water reservoir 34; (3) perform a first recirculation by operating the water pump 44, water fill valve 50, recirculation valve 52, and drain valve 54; (4) after the first recirculation, agitate the interior of the chamber 40 by admission of air at a pressure higher than that in the chamber 40 by operating the air agitation valve 48; (5) perform a second recirculation by operating the water pump 44, water fill valve 50, recirculation valve 52, and drain valve 54; (6) after the second recirculation, cycle the pressure in the chamber 40 between predetermined high and low pressures; (7) release some excess pressure in the chamber 40; (8) drain the chamber 40 of water into the waste reservoir 36; (9) reduce pressure in the chamber 40; and (10) release remaining excess pressure. Steps (1) through (10) in the sequence may be repeated two or more times, in an embodiment, with each iteration of steps (1) through (10) using clean water from the water reservoir 34.

Referring again to FIG. 1, once excess ink is removed from a cartridge with the vacuum 16, a remanufacturing process may advance to a number of additional testing, emptying, and filling steps. In a second step in the remanufacturing process, the electrical operation of the cartridge may be tested with one of the test modules 14 on the workstation 12. Testing the electrical operation may be one of the first steps in the remanufacturing process because it allows remanufacturers to screen out electronically defective print cartridges before unnecessary resources are expended on that print cartridge. Each of the test modules 14 may be configured to test the electrical operation of a cartridge. A cartridge may electrically fail due to, for example, worn contacts or faulty internal circuitry. The test module 14 may provide one or more electrical signals to a cartridge electrically coupled with the test module 14 and then monitor the electrical response of the cartridge. The electrical response of the cartridge may be compared to a desired response to determine if the cartridge is functioning properly or not. In an embodiment, the functionality of one or more of the test modules 14 may be similar to that described in U.S. Pat. No. 7,303,249, which is hereby incorporated by reference in its entirety.

To begin a test, a user may enter information about the print cartridge through the GUI 32, such as manufacturer and model number, although the workstation 12 may have capabilities to determine the type of print cartridge automatically. In an embodiment, the user may select the print cartridge from a menu or series of menus of supported cartridges. In the same or another embodiment, the user may scan a barcode on the cartridge with the barcode scanner 24, shown in FIG. 3. Once cartridge information is entered or determined, the workstation 12 may provide instructions for performing a test, such as which test module 14 to use for the cartridge. For example, each test module 14 may be associated with an indicator light that the workstation 12 may activate to indicate the proper test module 14 for a particular cartridge. Once a cartridge is inserted into a test module 14, the workstation may automatically perform a test. The results of the test may be reported through the GUI.

The workstation 12 may include a plurality of test modules 14, each configured in size, shape, and electrical contact layout for one or more particular cartridge types. For example, a first test module 14₁ may be configured for use with a first set of cartridges from a first original manufacturer, a second test module 14₂ configured for use with a second set of cartridges from the first manufacturer, a third test module 14₃ configured for use with a first set of cartridges from a second manufacturer, and so on. The test modules 14 may be installed and removed from the workstation 12 so that, as new cartridge models are introduced and/or old cartridge models fall out of use, the system may be modified or updated as appropriate.

Further, the test modules 14 may function as test printers to perform print quality tests where refilled print cartridges are used to print a high quality test patterns on pieces of paper. Thus a test print feeder 26, shown in FIG. 8, may be coupled with or integrated with the workstation 12. As a quality control check, the workstation 12 may have an optical sensor that examines each test pattern. However, in another embodiment, the operator of the workstation may visually inspect each test pattern. Exemplary test patterns for the user to compare with the printed test pattern may be provided by the workstation 12 through the GUI 32 on the display 18. Depending on the results of the print quality test, the print cartridge may leave the workstation 12 to be repackaged for resale, the print cartridge may be discarded, or the print quality test may be repeated. The print quality test may be performed after a cartridge is filled with ink, as described below, in an embodiment.

Based on the electrical test and/or print quality test, the workstation may record a functional status of the cartridge (e.g., functional or nonfunctional). As noted below, the recordation of functional status may be used in a quality management system.

After the electrical test, the cartridge may be further tested to assess the fluid flow functionality of the nozzles and ink passageways of the cartridge. In an embodiment, the fluid flow testing may be performed with a filling cradle 20. The fluid flow test may include pumping a predetermined amount of test fluid into the cartridge through the cartridge print head. The rate at which the cartridge admits the test fluid may be indicative of the fluid flow capabilities of the cartridge (i.e., the extent to which the nozzles and ink passageways are clear, blocked, or destroyed). As a result, the amount of time required to pump the test fluid into the cartridge may be monitored and compared to known pump times representative of acceptable fluid flow to determine whether the fluid flow of the cartridge is acceptable. Following the fluid flow test, the test fluid may be evacuated from the cartridge through the filling cradle 20.

The fluid flow process may be carried out automatically under the direction of the processing capabilities of the workstation 12, in an embodiment. For example, the workstation may be configured to (e.g., through its software, hardware, and other processing capabilities) initiate pumping of test fluid, monitor the amount of time required to pump the test fluid, and automatically assess the fluid flow functionality of the cartridge according to the amount of time (e.g., determine whether the cartridge passed or failed the fluid flow test) in comparison to known pump times representative of acceptable fluid flow.

The test fluid may be compatible with the chemistry of the inks used in the subsequent filling process. In an embodiment, the test fluid may be devoid of pigmentation or coloration so as not to contaminate either color or black cartridges during or after the test. Alternatively, black ink may be used as a test fluid for black ink cartridges. Furthermore, the test fluid may be fully miscible with the inks used in the filling process.

After a cartridge is tested, it may be filled with ink. For example, the print cartridge may be further emptied, cleansed, and filled with ink via one of the filling cradles 20. In an embodiment, the filling cradles may take on the structure and/or provide the functionality described in one or more of U.S. Pat. Nos. 7,628,181 and 7,665,819, both of which are hereby incorporated by reference in their entireties.

The workstation 12 may include a plurality of filling cradles 20, each configured in size, shape, and electrical contact layout for one or more particular cartridge types. For example, a first filling cradle 20₁ may be configured for use with a first set of cartridges from a first original manufacturer, a second filling cradle 20₂ configured for use with a second set of cartridges from the first manufacturer, a third filling cradle 20₃ configured for use with a first set of cartridges from a second manufacturer, and so on. The filling cradles 20 may be installed and removed from the workstation so that, as new cartridge models are introduced and/or old cartridge models fall out of use, the system may be modified or updated as appropriate.

A filling cradle 20 may insert ink into a cartridge through one or more needles 60 (shown disposed within the workstation 12 in FIG. 1) inserted into the body of the print cartridge or through the print head of the cartridge, in various embodiments. For example, a black ink print cartridge may be filled through the print head, and a color ink cartridge may be filled via needles 60. In needle embodiments, the filling cradle 20 may provide guides for inserting the needles 60 into the print cartridge.

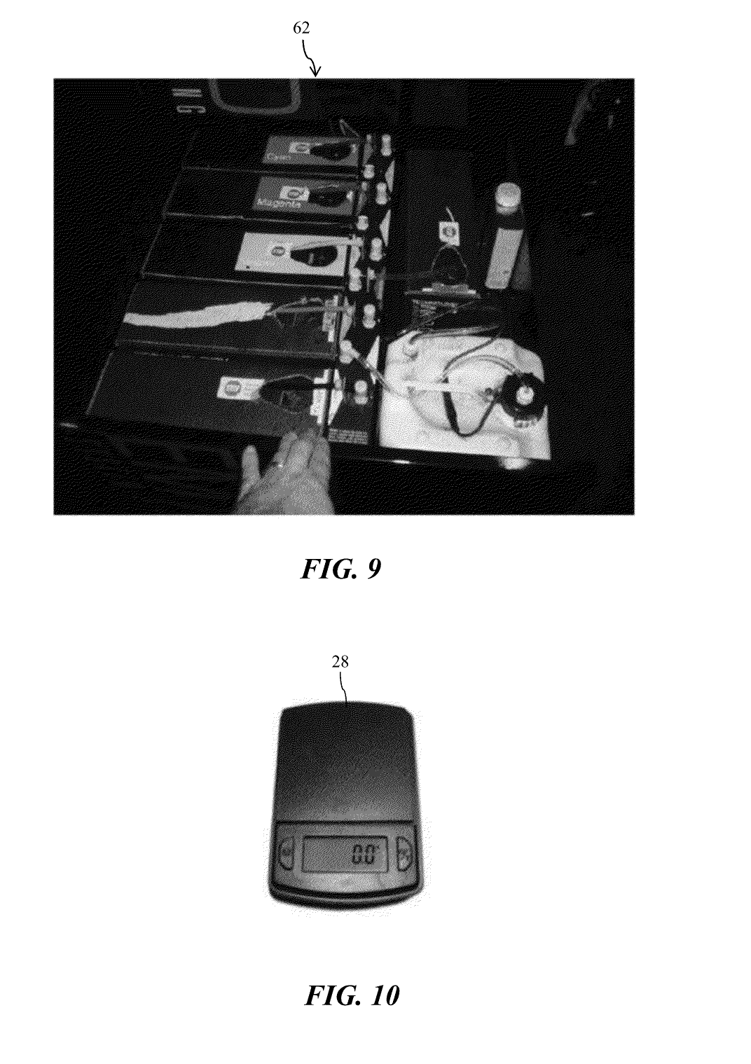

The filling cradles 20 and needles 60 may be fluidly coupled with ink reservoirs 62, shown in FIG. 9. Referring to FIGS. 1 and 9, the ink reservoirs 62 may be stored in the workstation drawers 22, and may be connected via detachable connections for simple replacement of the ink reservoirs 62.

The workstation 12 may provide instructions for filling a print cartridge through the GUI 32. For example, a user may be provided instructions for which filling cradle 20 to use for a particular cartridge. The workstation 12 may also provide feedback regarding the status of ink filling through the GUI 32, in an embodiment. And like the test modules 14, the filling cradles 20 may be associated with respective indicator lights, in an embodiment, which the workstation 12 may light to indicate the proper filling cradle 20 for a particular print cartridge.

Once a cartridge is filled, it may be weighed using a scale to determine that the correct amount of ink has been accepted by the cartridge. An exemplary scale 28 is shown in FIG. 10. The scale 28 may be electrically coupled with the workstation 12 to automatically provide the weight to the workstation 12, in an embodiment. In another embodiment, the scale 28 may be an independent component from the workstation 12 and the user can manually enter the weight. The workstation 12 may indicate a desired weight for the filled cartridge through the GUI 32. In the event that the actual weight of a filled cartridge is different from the desired weight, a user may have to refill the print cartridge.

The workstation 12 may, in some embodiments, be used to print a label for each print cartridge during or after the remanufacturing process. A label may be printed on adhesive-backed paper, in an embodiment, for application to a cartridge. An exemplary label printer 30 is shown in FIG. 11, and an exemplary label 64 is shown in FIG. 12. The label 64 may include a variety of information such as, for example, a unique barcode 66 that identifies each print cartridge, an abbreviation 68 representing the vendor and/or original equipment manufacturer (OEM), a cartridge model 70, a name of an operator 72 that refilled the print cartridge, one or more dates 74 on which the print cartridge was refilled, a location of the store at which the print cartridge was refilled, how many times the cartridge has been refilled, what types of ink the print cartridge has held, and the like.

Alternatively or in addition, an online database or a network may store all this exemplary information in a record dedicated to the particular print cartridge. The unique barcode 66 may identify the record of a particular print cartridge within the online database or network that would allow for the tracking and monitoring of the complete history of the print cartridge. Hence, some information may be omitted from the label 64, in embodiments.

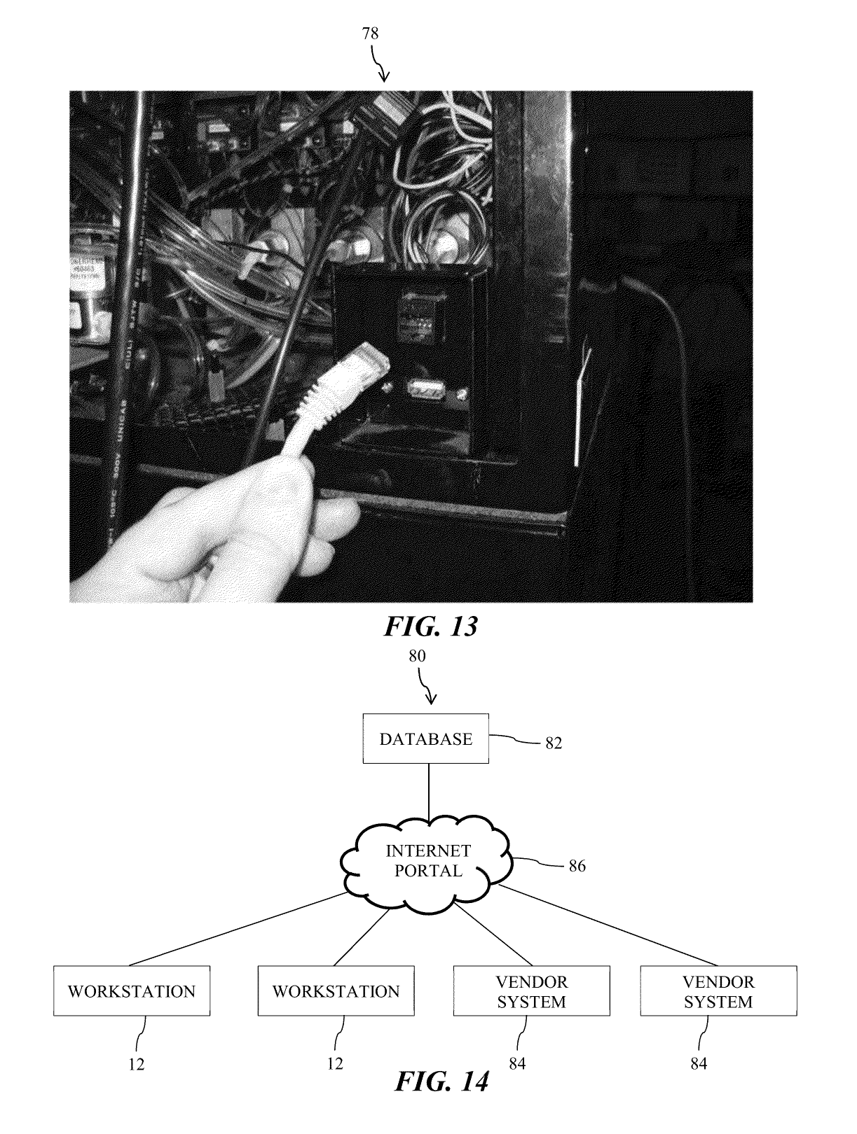

The workstation 12 may be configured for connection to an external network (e.g., the Internet) through, for example only, a wired network port 78 (an exemplary embodiment of which is shown in FIG. 13), a wireless connection, or both. The workstation 12 may be connected to the Internet, for example only, for the exchange of information about individual print cartridges, information about print cartridge manufacturers and models, and updates to software on the workstation 12, among other things. In an embodiment, the workstation 12 may upload and download information regarding individual print cartridges to/from a server or a cloud as part of a quality management system and process for remanufactured print cartridges.

The workstation 12 may be connected, through its network connection, to a quality management system. An exemplary quality management system 80, shown diagrammatically in FIG. 14, may include a database 82 connected to a plurality of workstations 12 and a plurality of vendor systems 84 through an internet portal 86. The quality management system 80 may allow vendors and remanufacturers to have transparent access to remanufacturing data, including statistics on remanufacturing, product supplies, accounting, failure rates, etc., creating a transparent market for buying and selling of remanufactured print cartridges and related components.

Although only workstations 12 and vendor systems 84 are shown in FIG. 14 connected to the database 82, the data and functionality provided by the database 82 may more generally be accessible through the internet portal 84 to systems of vendors, remanufacturers, and others, regardless of the system used to access such data and functionality. Accordingly, it should be understood that the illustrated workstations 12 and vendor systems 84 are intended as non-limiting examples only.

In one embodiment, the quality management system 80 may record and store the quality of print cartridges, particularly the ability of particular print cartridges to be successfully remanufactured. It is known that a fraction of all print cartridges are not remanufacturable. This may be discovered, for example, after the print cartridge is tested at the test module 14 of a workstation 12 (see FIG. 1). Or this may be discovered only after a remanufactured print cartridge is resold to a consumer or business. In the later case, the customer or business will likely report the failure of the print cartridge. In some embodiments, it may help to incentivize the consumer to report failures by promising to replace the print cartridge upon failure, for example.

In the event that a print cartridge fails, the failure may be reflected in the record identified for the print cartridge by the barcode 66 on the print cartridge's label 64 (see FIG. 12). A workstation 12 may upload information regarding the failure to the network or database 82. Vendors may have access to the database 82 (e.g., for uploading and retrieving information) via the internet portal 86. In one embodiment, if a faulty print cartridge is returned to the vendor, the vendor can obtain further details about the failure from reading the barcode 66 and can upload information about the failure to the database 82.

In any remanufacturing iteration (i.e., whether successful or not), the functional status of the cartridge (e.g., functional or non-functional) may be recorded by a workstation 12 and uploaded to the database 82. The recorded functional status may be altered if, for example, a customer returns a cartridge or if a faulty cartridge is repaired.

The database 82 may be configured to generate and provide, through the internet portal 86, reports including statistics that vendors can customize based on region, OEM, print cartridge model, year of production, number of remanufactures, and so on. In short, the statistics may be broken down per each vendor's preferences, per each piece of information associated with each print cartridge. In turn, vendors may be able to compare their return data and return trends with their competitors' return data and trends. Moreover, print cartridge remanufacturers may be able to view their return data and modify their purchasing patterns.

Using the quality management system 80 to track the quality of print cartridges may be particularly helpful where new print cartridges are introduced into the market. When a new print cartridge is introduced, vendors and print cartridge remanufacturers may not know the probabilities of successfully remanufacturing the print cartridge. By collecting data on the database 82, vendors and remanufacturers may be able to quickly hone aftermarket buying and selling prices for the print cartridge. As an extension of this, vendors and remanufacturers may also be able to determine price points for commodities associated with the remanufacture of the particular print cartridge, such as ink, paper, and labels, for example.

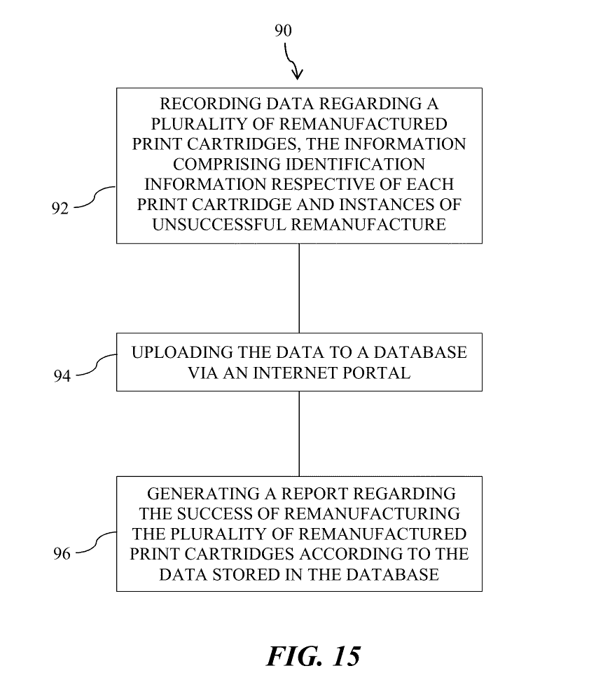

To track the remanufacturability of print cartridges, a method may be executed by the quality management system 80. An exemplary method 90 is shown in block diagram form in FIG. 15. The method 90 may include a number of steps, including a first step 92 of recording data regarding a plurality of remanufactured print cartridges, the information comprising identification information respective of each print cartridge and instances of unsuccessful remanufacture. Recorded information may include region, OEM, print cartridge model, year of production, number of remanufactures, number of successful and unsuccessful remanufactures, and causes of unsuccessful remanufactures. The data may be recorded by the remanufacturing workstations 12 that remanufacture the cartridges, in embodiments. Another step 94 of the method may include uploading the data, by the workstations, to the database via the internet portal.

Yet another step 96 may include generating a report according to the data stored in the database regarding the remanufacturability of one or more cartridges. The report may be generated by a workstation 12, by the database 82 (e.g., by a computing system coupled to the database), or by another computing system with access to the data in the database 82. The report may include correlated data regarding cartridges of a particular manufacturer or model, in an embodiment. Such correlation may be performed by a workstation 12, by the database 82, or by another computing system with access to the data in the database.

Reports may additionally or alternatively include any manner of information regarding remanufactured cartridges, such as failure rates, failure causes, dates and locations of remanufacture, number of remanufactures, and any other information respective of an individual print cartridge or a plurality of print cartridges. Access to the data and to reports generated by the database 82 may be provided to the workstations 12 and vendor systems 84 through the internet portal 86.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A system for remanufacturing print cartridges, the system comprising:
a workstation comprising:
a test module configured to perform an electrical test on contacts of a first print cartridge and perform a print quality test on the first print cartridge; and
a filling cradle configured to fill the first print cartridge with ink; and
a vacuum comprising a chamber configured to contain at least the first print cartridge and a second print cartridge, wherein the vacuum is controlled by said workstation and is configured to evacuate ink or toner from the first and the second print cartridge.

2. The system of claim 1, wherein the workstation further comprises the vacuum.

3. The system of claim 1, wherein the workstation is configured to provide a graphical user interface through which a user may control print cartridge remanufacture.

4. The system of claim 3, further comprising a display through which the workstation is configured to provide the graphical user interface.

5. The system of claim 3, wherein the workstation is configured to provide instructions for remanufacturing the first print cartridge through the graphical user interface.

6. The system of claim 5, wherein the instructions comprise instructions for evacuating ink with the vacuum, testing with the test module, and filling with the filling cradle.

7. The system of claim 1, wherein the workstation is configured to input information to a database regarding the functional status of the first print cartridge according to one or more of the electrical test and the print quality test.

8. The system of claim 1, further comprising a scale configured to output a weight of the first print cartridge.

9. The system of claim 1, wherein the vacuum is configured to perform one or more of:
create a pressure differential between the exterior of the chamber and the interior of the chamber;
fill the chamber with fluid;
circulate the fluid in the chamber; and
cycle the pressure in the chamber between a predetermined high pressure and a predetermined low pressure.

10. The system of claim 9, wherein the vacuum is coupled with a water reservoir and a separate waste reservoir.

11. The system of claim 1, wherein the workstation is configured to monitor an amount of time needed to pump a predetermined amount of fluid into the first cartridge.

12. The system of claim 11, wherein the workstation is further configured to assess the fluid flow functionality of the first cartridge according to the amount of time.

13. A method of tracking remanufactured print cartridges, the method comprising:
recording data regarding a plurality of remanufactured print cartridges, the information comprising identification information respective of each print cartridge and instances of unsuccessful remanufacture;
uploading the data to a database via an internet portal; and
generating a report regarding the success of remanufacturing the plurality of remanufactured print cartridges according to the data stored in the database.

14. The method of claim 13, further comprising downloading the stored data from the database and generating the report at a workstation remote from the database.

15. The method of claim 13, further comprising recording a cause of unsuccessful remanufacture for a print cartridge that is unsuccessfully remanufactured.

16. The method of claim 15, further comprising uploading the cause to the database.

17. The method of claim 16, wherein uploading the cause is performed automatically by a cartridge remanufacturing workstation following a determination by the workstation that the cartridge for which remanufacture is attempted failed a test.

18. The method of claim 15, further comprising compiling common causes of unsuccessful remanufacture for cartridges of a common manufacturer.

19. The method of claim 18, further comprising compiling common causes of unsuccessful remanufacture for cartridges of a common model.

20. The method of claim 18, wherein the common causes are included in the report.
